(19) United States
(12) Patent Application Publication
(10) Pub. No.: US 2013/0000845 A1
(43) Pub. Date: Jan. 3, 2013

(54) Device and Method for Measuring Thickness of Slurry and Chemical Mechanical Polishing Apparatus Comprising the Device

(75) Inventors: Xinchun Lu, Beijing (CN); Dewen Zhao, Beijing (CN); Yongyong He, Beijing (CN); Jianbin Luo, Beijing (CN)

(73) Assignee: Tsinghua University, Beijing (CN)

(21) Appl. No.: 13/387,964

(22) PCT Filed: Jun. 7, 2011
(86) PCT No.: PCT/CN2011/075423

§ 371 Date: Jul. 16, 2012

(30) Foreign Application Priority Data
Mar. 10, 2011 (CN) 201110058422.0

(51) Int. Cl. G01B 7/06; B44C 1/22

(52) U.S. Cl. 156/345.13; 324/229

(57) ABSTRACT

A device for measuring a thickness of a slurry used in a chemical mechanical polishing apparatus and a method using the same are provided. The chemical mechanical polishing apparatus comprises a polishing head (10), a rotary table (20), a polishing platen (30) and a polishing pad (40). The device for measuring the thickness of the slurry comprises: a distance sensor (50) disposed in the polishing platen (30) for measuring a distance between the distance sensor (50) and a wafer (11) in the polishing head (10); a processing unit (70) (60) disposed in the rotary table (20) and connected to the distance sensor (50) for converting a measuring signal from the distance sensor (50) into standard electrical signal; a processing unit (70) connected to distance converters (60) for acquiring the standard electrical signal to obtain a thickness of the slurry between the polishing head (10) and the polishing pad (40). A chemical mechanical polishing apparatus comprising the device for measuring the thickness of the slurry is also provided.

### FIELD

The present disclosure relates to a device for measuring a thickness of a slurry used in a chemical mechanical polishing apparatus, a method for measuring the thickness of the slurry using the device, and a chemical mechanical polishing apparatus including the device for measuring the thickness of the slurry.

### BACKGROUND

A planarization polishing process of a film attached on a surface of a wafer is required to perform in order to satisfy the subsequent processing requirements during a process of fabricating an integrated circuit. Chemical mechanical polishing (CMP) is a widely used planarization method currently.

A basic principle of CMP is that: rotations of a polishing head and a polishing pad may generate a relative motion required by polishing. A wafer is carried in the polishing head and the polish pad is attached onto a surface of a polish disk. A predetermined pressure is applied by the polishing head to press the wafer onto a surface of the polish pad. With the aid of the relative motion between the wafer and the polishing pad, and with the polishing particles in a slurry, precise polishing may be realized.

On one hand, a high material removal rate is required by CMP to improve production efficiency, on the other hand, a high uniformity should be ensured so as to control the non-uniformity in a reasonable extent. Otherwise, the wafer may be scrapped. In order to obtain a better flatness, the polishing process parameters is needed to be accurately controlled.

In the CMP process, material removal is achieved with the combined action of a mechanical action from the abrasive particles and a chemical action from chemical components of the slurry. In addition to the influence of the mechanical action, another important factor to influence the planarization effect of CMP is the distribution of the slurry between the wafer and the polishing pad. The actual distribution of the thickness of the slurry between the wafer and the polishing pad is significant for studying the influence of the distribution of the slurry on the polishing uniformity.

Up to now, except some fluorescent methods of simulating and studying flow field distribution of the CMP process, good methods for in-situ measuring the distribution of the thickness of the slurry during the CMP process have not appeared.

### SUMMARY

The present disclosure is directed to solve at least one of problems existing in the prior art.

Therefore, an object of the present disclosure is to provide a device used in a chemical mechanical polishing apparatus to in-suit measure a thickness of a slurry between a polishing head and a polishing pad.

Another object of the present disclosure is to provide a method for in-suit measuring the thickness of the slurry using the device for measuring the thickness of the slurry.

Yet another object of the present disclosure is to provide a chemical mechanical polishing apparatus including the device for measuring the thickness of the slurry.

In order to achieve the above objects, according to embodiments of a first aspect of the present disclosure, a device for measuring the thickness of the slurry used in the chemical mechanical polishing apparatus is provided. The chemical mechanical polishing apparatus comprises the chemical mechanical polishing apparatus comprising a polishing head, a rotary table, a polishing platen disposed on an upper surface of the rotary table, and a polishing pad disposed on an upper surface of the polishing platen and opposed to the polishing head. The device for measuring the thickness of the slurry comprises: a distance sensor disposed in the polishing platen for measuring a distance between the distance sensor and a wafer in the polishing head; a distance converter disposed in the rotary table and coupled to the distance sensor for converting a measuring signal from the distance sensor into a standard electrical signal; and a processing unit coupled to the distance converter for acquiring the standard electrical signal to obtain a thickness of the slurry between the polishing head and the polishing pad.

With the device for measuring the thickness of the slurry used in the chemical mechanical polishing apparatus of the embodiment of the present disclosure, the distance sensor is disposed in the polishing platen, and the distance sensor rotates with the polishing platen during the POLISHING process so as to sector scan the whole surface of the wafer, so that the device for measuring the thickness of the slurry may in-suit measure the thickness of the slurry between the polishing head and the polishing pad (i.e., a thickness of the slurry between the wafer and the polishing pad). The device for measuring the thickness of the slurry also has the distance converter coupled to the distance sensor for converting the measuring signal of the distance sensor into the standard electrical signal, and also has the processing unit coupled to the distance converter for in-suit obtaining the thickness of the slurry.

In some embodiments, a first groove is formed in the upper surface of the rotary table and covered by the polishing platen to define a first chamber in which the distance converter is disposed.

In some embodiments, a second groove is formed in the upper surface of the polishing platen and covered by the polishing pad to define a second chamber in which the distance sensor is disposed.

In some embodiments, the device for measuring the thickness of the slurry further comprises a mounting panel disposed in the second chamber, in which the distance sensor is mounted on the mounting panel. By disposing the mounting panel in the second chamber, the distance sensor (especially a plurality of distance sensors) may be more conveniently disposed in the second chamber.

In some embodiments, a plurality of distance sensors are arranged along a radial direction of the polishing platen at intervals. By disposing the plurality of distance sensors to simultaneously measure the thickness of the slurry between the wafer and the polishing pad at different positions, the measuring data density may be increased so that a distribution of the thickness of the slurry may be obtained more accurately.

In some embodiments, the plurality of distance sensors are arranged along the radial direction of the polishing platen at equal intervals.

In some embodiments, the plurality of distance sensors are arranged along a plurality of radial directions of the polishing platen to form a plurality of one-dimensional linear arrays. Therefore, the measuring data density may be further increased so that the distribution of the thickness of the slurry may be obtained more accurately.

In some embodiments, a plurality of mounting panels are provided and the plurality of one-dimensional linear arrays are correspondingly mounted on the plurality of mounting panels.

In some embodiments, distances from the plurality of distance sensors to an upper surface of the polishing pad or the upper surface of the polishing platen are equal.

In some embodiments, the distance sensor is an eddy current distance sensor. In some embodiments, the processing unit further comprises: a slip ring having a rotating part mounted on the rotary table and coupled to the distance sensor, in which a rotating central axis of the rotating part of the slip ring coincides with a rotating central axis of the rotary table; an acquisition card coupled to a static part of the slip ring for acquiring the standard electrical signal; a signal converter coupled to the acquisition card for converting the standard electrical signal into a digital signal; a calculation module coupled to the signal converter for calculating the thickness of the slurry using the digital signal; and a display terminal coupled to the calculation module for displaying the thickness of the slurry.

According to embodiments of a second aspect of the present disclosure, a chemical mechanical polishing apparatus is provided. The chemical mechanical polishing apparatus comprises: a rotary table; a polishing platen disposed on an upper surface of the rotary table; a polishing pad disposed on an upper surface of the polishing platen; a polishing head opposed to the polishing pad; and the device for measuring the thickness of the slurry according to embodiments of the first aspect of the present disclosure, in which the distance sensor is disposed in the polishing platen for measuring a distance between the distance sensor and a wafer in the polishing head, the distance converter is disposed in the rotary table and coupled to the distance sensor for converting a measuring signal from the distance sensor into a standard electrical signal, and the processing unit is coupled to the distance converter for acquiring the standard electrical signal to obtain the thickness of the slurry between the polishing head and the polishing pad.

With the chemical mechanical polishing apparatus according to an embodiment of the present disclosure, by employing the device for measuring the thickness of the slurry in accordance with embodiments of the first aspect of the present disclosure, the thickness of the slurry between the polishing head and the polishing pad may be in-suit measured and obtained. Therefore, the flatness of the wafer may be improved.

In some embodiments, a first groove is formed in the upper surface of the rotary table and covered by the polishing platen to define a first chamber, in which the distance converter is disposed in the first chamber.

In some embodiments, a second groove is formed in the upper surface of the polishing platen has and covered by the polishing pad to define a second chamber, in which the distance sensor is disposed in the second chamber.

According to embodiments of a third aspect of the present disclosure, a method for measuring the thickness of the slurry is provided. The method comprises the steps of: A) a static loading measurement, comprising: statically loading the wafer using the polishing head, sector scanning a whole surface of the wafer using the distance sensor of the device for measuring thickness of the slurry according to embodiments of the first aspect of the present disclosure, and measuring a distance between the distance sensor and a metal layer on the surface of the wafer using the distance sensor, thus obtaining a first distance; and B) a dynamic rotating measurement, comprising: chemical mechanical polishing the wafer, and measuring the distance between the distance sensor and the metal layer on the surface of the wafer using the distance sensor in a same way as that in Step A) to obtain a second distance, and calculating a difference between the second distance and the first distance as a thickness of the slurry.

With the method of an embodiment of the present disclosure, by using the distance sensor of the device for measuring the thickness of the slurry to sector scan the whole surface of the wafer, the thickness of the slurry between the polishing head and the polishing pad may be in-suit measured and obtained.

Additional aspects and advantages of the embodiments of the present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of present disclosure will become apparent and more readily appreciated from the following descriptions taken in conjunction with the drawings in which:

FIG. 1 is a schematic structure view of a device for measuring a thickness of a slurry according to an embodiment of the present disclosure;

FIG. 2 is a top view of the device for measuring the thickness of the slurry according to the embodiment of the present disclosure shown in FIG. 1;

FIG. 3 is a schematic view showing measuring the thickness of the slurry using the device for measuring the thickness of the slurry according to an embodiment of the present disclosure;

FIG. 4 is a schematic view showing a step of a static loading measurement for measuring the thickness of the slurry using the device for measuring the thickness of the slurry according to an embodiment of the present disclosure;

FIG. 5 is a schematic view showing a step of a dynamic rotating measurement for measuring the thickness of the slurry using the device for measuring the thickness of the slurry according to an embodiment of the present disclosure.

### REFERENCE SIGNS

polishing head 10, wafer 11, rotary table 20, first chamber 21, polishing platen 30, second chamber 31, polishing pad 40, distance sensor 50, distance converter 60, processing unit 70, slip ring 71, an acquisition card 72, display terminal 73, mounting panel 80.

### DETAILED DESCRIPTION

Embodiments of the present disclosure will be described in detail in the following descriptions, examples of which are shown in the accompanying drawings, in which the same or similar elements and elements having same or similar functions are denoted by like reference numerals throughout the descriptions. The embodiments described herein with reference to the accompanying drawings are explanatory and illustrative, which are used to generally understand the present disclosure. The embodiments shall not be construed to limit the present disclosure.

In the description, relative terms such as “longitudinal”, “lateral”, “front”, “rear”, “right”, “left”, “lower”, “upper”, “horizontal”, “vertical”, “above”, “below”, “up”, “top”, “bottom” as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation.

In addition, terms such as “first” and “second” are used herein for purposes of description and are not intended to indicate or imply relative importance or significance.

In the description, terms concerning attachments, coupling and the like, such as “coupled” and “intercoupled”, refer to a relationship wherein structures are secured or attached to one another through mechanical or electrical connection, or directly or indirectly through intervening structures, unless expressly described otherwise. Specific implications of the above phraseology and terminology may be understood by those skilled in the art according to specific situations.

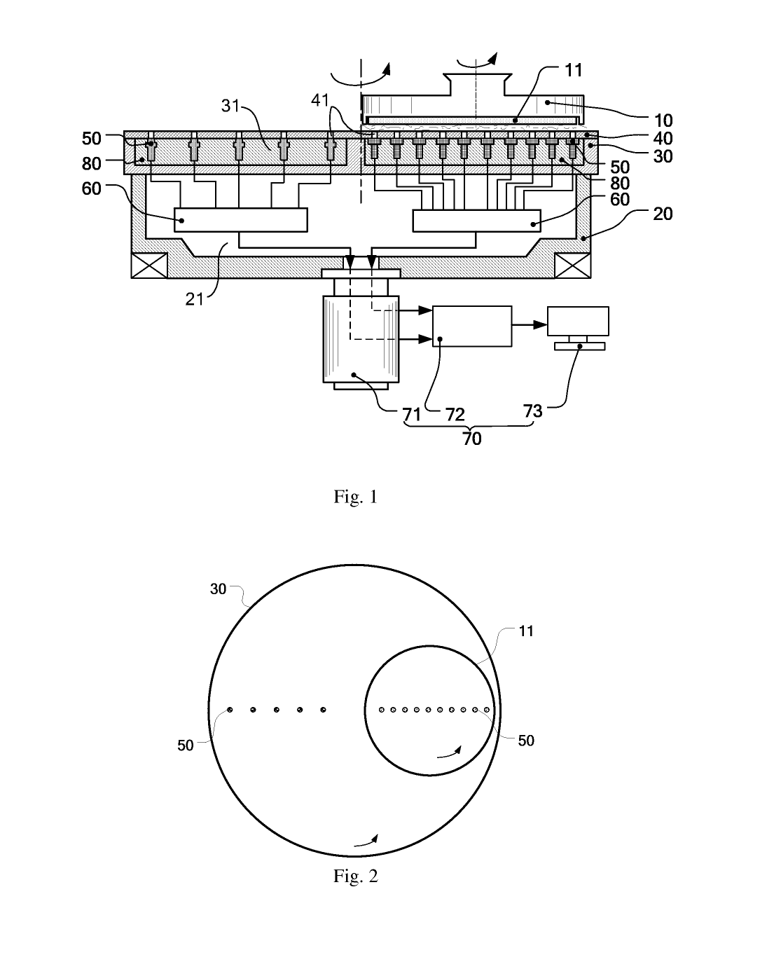

A device for measuring a thickness of a polishing slurry used in the chemical mechanical polishing apparatus according to an embodiment of the present disclosure will be described referring to FIG. 1 and FIG. 2. As shown in FIG. 1 and FIG. 2, the chemical mechanical polishing apparatus comprises a polishing head 10, a rotary table 20, a polishing platen 30 disposed on an upper surface of the rotary table 10 and a polishing pad 40 disposed on an upper surface of the polishing platen 30 and opposed to the polishing head 10. The device for measuring the thickness of the slurry comprises a distance sensor 50, a distance converter 60 and a processor 70. The distance sensor 50 is disposed in the polishing platen 30 for measuring a distance between the distance sensor 50 and a wafer 11 in the polishing head 10. The distance converter 60 is disposed in the rotary table 20 and coupled to the distance sensor 50 for converting a measuring signal of the distance sensor 50 into a standard electrical signal. A processing unit 710 is coupled to the distance converter 60 for acquiring the standard electrical signal to obtain the thickness of the polishing slurry between the polishing head 10 and the polishing pad 40.

With the device for measuring the thickness of the slurry used in the chemical mechanical polishing apparatus according to embodiments of present disclosure, the distance sensor 50 is disposed in the polishing platen 30, and the distance sensor 50 rotates with the polishing platen 30 during the polishing process so as to sector scan a whole surface of the wafer, so that the device for measuring the thickness of the slurry may in-suit measure the thickness of the slurry between the polishing head 10 and the polishing pad 40 (i.e., a thickness of the slurry between the wafer 11 and the polishing pad 40). The device for measuring the thickness of the slurry also has the distance converter 60 coupled to the distance sensor 50 for converting the measuring signal of the distance sensor 50 into the standard electrical signal, and the processing unit 70 coupled to the distance converter 60 for in-suit obtaining the thickness of the slurry.

In some embodiments of the present disclosure, a first groove is formed in the upper surface of the rotary table 20 and covered by the polishing platen 30 to define a first chamber 21, and the distance converter 60 is disposed in the first chamber 21.

As shown in FIG. 1 and FIG. 2, a plurality of distance sensors 50 are arranged along a radial direction of the polishing platen 30 at intervals to form a one-dimensional linear array. By disposing the plurality of distance sensors 50 to simultaneously measure the thickness of the slurry between the wafer 11 and the polishing pad 40 at different positions, the measuring data density may be increased so that a distribution of the thickness of the slurry may be obtained more accurately. In an embodiment, the plurality of distance sensors 50 are arranged along the radial direction of the polishing platen 30 at intervals to form the one-dimensional linear array. Specifically, the plurality of distance sensors 50 are arranged along the radial direction of the polishing platen 30 at equal intervals.

In an embodiment, the plurality of distance sensors are arranged along a plurality of radial directions of the polishing platen to form a plurality of one-dimensional linear arrays. Therefore, the measuring data density may be further increased so that the distribution of the thickness of the slurry may be obtained more accurately. Each one-dimensional linear array may comprise one or a plurality of distance sensors 50. Specifically, the plurality of one-dimensional linear arrays may be uniformly disposed in the polishing platen 30, that is, the plurality of one-dimensional linear arrays may be disposed in the polishing platen 30 at equal angle intervals in the circumferential direction of the wafer, that is, the angles of the two adjacent one-dimensional linear arrays may be equal (e.g. 90 degree).

In some embodiments, the polishing platen 30 may be formed with a mounting hole, in which the distance sensor 50 may be mounted. When there is one distance sensor 50, one mounting hole may be formed so that one distance sensor 50 may be disposed in the one mounting hole. When there are a plurality of distance sensors 50, a plurality of mounting holes may be formed so that the plurality of distance sensors 50 may be correspondingly mounted in the plurality of mounting holes.

Referring to FIG. 1, in some embodiments, a second groove may be formed in the upper surface of the polishing platen 30 and covered by the polishing pad 40 to define a second chamber 31, and the distance sensor 50 is disposed in the second chamber 31. When the number of the distance sensors 50 is large, the distance sensors 50 may be more conveniently disposed by forming the second groove in the upper surface of the polishing platen 30.

In one embodiment, the device for measuring the thickness of the slurry may further comprise a mounting panel 80 disposed in the second chamber 31, and the distance sensor 50 may be mounted on the mounting panel 80. By disposing the mounting panel 80 in the second chamber 31, the distance sensor 50 (especially when there are a plurality of distance sensors 50) may be more conveniently disposed in the second chamber 31, and the plurality of distance sensors 50 may be more conveniently and accurately arranged along the radial direction of the polishing platen 30 at intervals. Specifically, the mounting panel 80 may have a shape of a long strip having two arc-shaped ends so as to fit with an internal wall of the second chamber 31.

In some embodiments, a plurality of mounting panels 80 are provided and the plurality of one-dimensional linear arrays are correspondingly mounted on the plurality of mounting panels 80. That is, one one-dimensional linear array may be mounted on one mounting panel 80.

The distance sensor 50, which may be a conventional sensor for measuring a distance, may measure the distance between the distance sensor 50 and a metal layer on the surface of the wafer. Specifically, the distance sensor 50 may be an eddy current distance sensor. In one embodiment, distances from the plurality of distance sensors 50 to the upper surface of the polishing pad 10 or the polishing platen 30 are equal.

Referring to FIG. 1, in some embodiments, the processing unit 70 may comprise a slip ring 71, an acquisition card 72, a signal converter, a calculation module and a display terminal 73. The slip ring 71 may have a rotating part mounted on the rotary table 20 and coupled to the distance sensor 60, and a rotating central axis of the rotating part of the slip ring 71 coincides with a rotating central axis of the rotary table 20. Thus, the rotating part of the slip ring 71 may be rotated along with the rotary table 20. The acquisition card 72 may be coupled to a static part of the slip ring 71 for acquiring the standard electrical signal. The signal converter may be coupled to the acquisition card 72 for converting the standard electrical signal into a digital signal. The calculation module may be coupled to the signal converter for calculating the thickness of the slurry using the digital signal. The display terminal 73 may be coupled to the calculation module for displaying the thickness of the slurry. Specifically, the display terminal 73 may be a conventional display. In one embodiment, a computer comprising the signal converter, the calculation module and the display terminal 73 may be used to connect to the acquisition card 72.

A chemical mechanical polishing apparatus according to an embodiment of the present disclosure will be described below with reference to FIG. 1. As shown in FIG. 1, the chemical mechanical polishing apparatus according to an embodiment of the present disclosure comprises a rotary table 20, a polishing platen 30, a polishing pad 40, a polishing head 10 and a device for measuring a thickness of a slurry. The polishing platen 30 is disposed on an upper surface of the rotary table 20. The polishing pad 40 is disposed on an upper surface of the polishing platen 30. The polishing head 10 is opposed to the polishing pad 40. The device for measuring the thickness of the slurry is the abovementioned device for measuring the thickness of the slurry. The distance sensor 50 is disposed in the polishing platen 30 for measuring a distance between the distance sensor 50 and a wafer 11 in the polishing head 10. The distance converter 60 is disposed in the rotary table 20 and coupled to the distance sensor 50 for converting a measuring signal from the distance sensor 50 into a standard electrical signal. The processing unit 70 is coupled to the distance converter 60 for acquiring the standard electrical signal to obtain the thickness of the slurry between the polishing head 10 and the polishing pad 40.

With the chemical mechanical polishing apparatus according to an embodiment of the present disclosure, by providing the device for measuring the thickness of the slurry, the thickness of the slurry between the wafer 11 and the polishing pad 40 may be in-suit measured and obtained. Thus, a flatness of the wafer 11 may be improved by chemical mechanical polishing the wafer 11 using the chemical mechanical polishing apparatus.

In one embodiment, a first groove may be formed in an upper surface of the rotary table 20 and covered by the polishing platen 30 to define a first chamber 21, and the distance converter 60 is disposed in the first chamber 21. In another embodiment, as shown in FIG. 1, a second groove may be formed in the upper surface of the polishing platen 30 and covered by the polishing pad 40 to define a second chamber 31, and the distance sensor 50 is disposed in the second chamber 31. When the number of the distance sensors 50 is large, the distance sensors 50 may be more conveniently disposed by forming the second groove in the upper surface of the polishing platen 30.

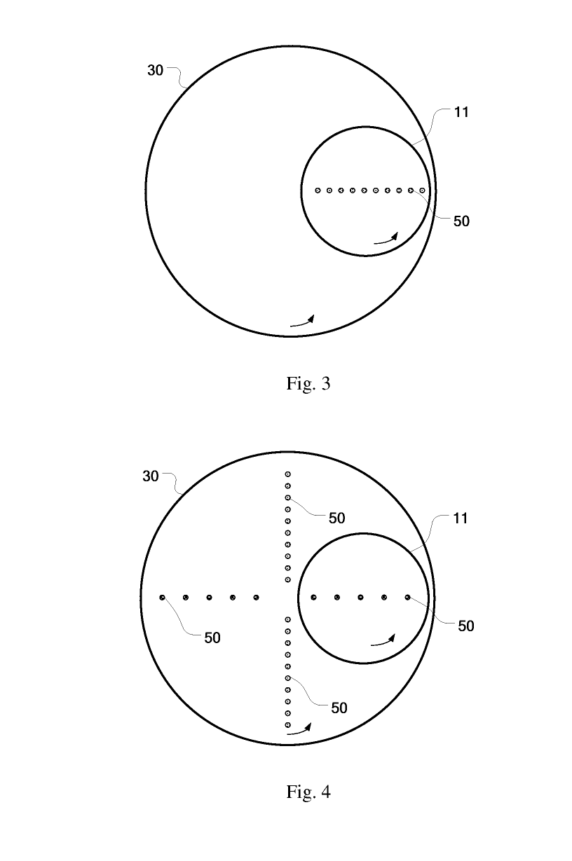

A method for measuring a thickness of a slurry according to an embodiment of the present disclosure will be described below with reference to FIGS. 3-5. As shown in FIGS. 3-5, the method according to an embodiment of the present disclosure comprises the following steps.

A) As shown in FIG. 4, a static loading measurement comprises: statically loading the wafer 11 using the polishing head 10 when both the wafer 11 and the polishing head 10 are not rotated; sector scanning a whole surface of the wafer 11 using the distance sensor 50 of the abovementioned device for measuring the thickness of the slurry (as shown in FIG. 3); and measuring the distance between the distance sensor 50 and the metal layer on the surface of the wafer using the distance sensor 50, thus obtaining a first distance.

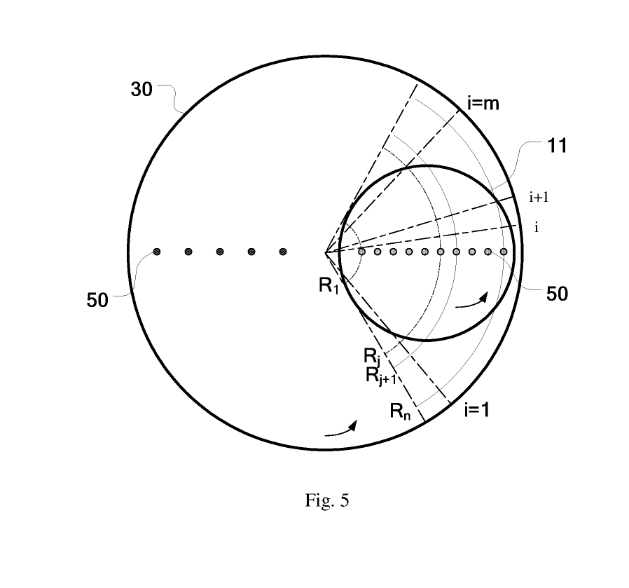

B) As shown in FIG. 5, a dynamic rotating measurement comprises: chemical mechanical polishing the wafer 11; measuring the distance between the distance sensor 50 and the metal layer on the surface of the wafer using the distance sensor 50 in a same way as that in Step A) to obtain a second distance; and calculating a difference between the second distance and the first distance as the thickness of the slurry.

Specifically, as shown in FIG. 3, Rⱼ is a radial position of the distance sensor 50, j is a serial number of the distance sensor 50, and i is a serial number of an acquisition angle position of distance measuring data. An angle position interval between two adjacent acquisitions may be controlled by controlling a sampling frequency of the acquisition card 72 according to requirements. The distance sensor 50 is rotated with the polishing platen 30 to sector scan the whole surface of the wafer 11 by the distance sensor 50, so that a distribution of the thickness of the slurry between the wafer 11 and the polishing pad 40 may be obtained. For instance, the number of the distance sensors 50 is n, and the acquisition number of the distance measuring data is m. Thus, m×n data may be obtained when the distance sensor 50 is rotated with the polishing platen 30 through 360 degrees. As shown in FIG. 3, an acquisition of distance measuring data starts in the position of i=1, and ends in the position of i=m.

With the device for measuring the thickness of the slurry used in the chemical mechanical polishing apparatus according to an embodiment of the disclosure, the thickness of the slurry between the polishing head 10 and the polishing pad 40 may be in-suit measured and obtained. Thus, a flatness of the wafer 11 may be improved using the chemical mechanical polishing apparatus comprising the device for measuring the thickness of the slurry.

Reference throughout this specification to “an embodiment”, “some embodiments”, “one embodiment”, “an example”, “a specific examples”, or “some examples” means that a particular feature, structure, material, or characteristic described in connection with the embodiment or example is included in at least one embodiment or example of the disclosure. Thus, the appearances of the phrases such as “in some embodiments”, “in one embodiment”, “in an embodiment”, “an example”, “a specific examples”, or “some examples” in various places throughout this specification are not necessarily referring to the same embodiment or example of the disclosure. Furthermore, the particular features, structures, materials, or characteristics may be combined in any suitable manner in one or more embodiments or examples.

Although explanatory embodiments have been shown and described, it would be appreciated by those skilled in the art that changes, alternatives, and modifications all falling into the scope of the claims and their equivalents may be made in the embodiments without departing from spirit and principles of the disclosure.

1. A device for measuring a thickness of a slurry used in a chemical mechanical polishing apparatus, the chemical mechanical polishing apparatus comprising a polishing head, a rotary table, a polishing platen disposed on an upper surface of the rotary table, and a polishing pad disposed on an upper surface of the polishing platen and opposed to the polishing head, the device comprising:
a distance sensor disposed in the polishing platen for measuring a distance between the distance sensor and a wafer in the polishing head;
a distance converter disposed in the rotary table and coupled to the distance sensor for converting a measuring signal from the distance sensor into a standard electrical signal; and
a processing unit coupled to the distance converter for acquiring the standard electrical signal to obtain a thickness of the slurry between the polishing head and the polishing pad.

2. The device according to claim 1, wherein a first groove is formed in the upper surface of the rotary table and covered by the polishing platen to define a first chamber in which the distance converter is disposed.

3. The device according to claim 1, wherein a second groove is formed in the upper surface of the polishing platen and covered by the polishing pad to define a second chamber in which the distance sensor is disposed.

4. The device according to claim 3, further comprising a mounting panel disposed in the second chamber, in which the distance sensor is mounted on the mounting panel.

5. The device according to claim 4, wherein a plurality of distance sensors are arranged along a radial direction of the polishing platen at intervals.

6. The device according to claim 5, wherein the plurality of distance sensors are arranged along the radial direction of the polishing platen at equal intervals.

7. The device according to claim 5, wherein the plurality of distance sensors are arranged along a plurality of radial directions of the polishing platen to form a plurality of one-dimensional linear arrays.

8. The device according to claim 7, wherein a plurality of mounting panels are provided and the plurality of one-dimensional linear arrays are correspondingly mounted on the plurality of mounting panels.

9. The device according to claim 5, wherein distances from the plurality of distance sensors to an upper surface of the polishing pad or the upper surface of the polishing platen are equal.

10. The device according to claim 1, wherein the distance sensor is an eddy current distance sensor.

11. The device according to claim 1, wherein the processing unit comprises:
a slip ring having a rotating part mounted on the rotary table and coupled to the distance sensor, in which a rotating central axis of the rotating part of the slip ring coincides with a rotating central axis of the rotary table;
an acquisition card coupled to a static part of the slip ring for acquiring the standard electrical signal;
a signal converter coupled to the acquisition card for converting the standard electrical signal into a digital signal;
a calculation module coupled to the signal converter for calculating the thickness of the slurry using the digital signal; and
a display terminal coupled to the calculation module for displaying the thickness of the slurry.

12. A chemical mechanical polishing apparatus, comprising:
a rotary table;
a polishing platen disposed on an upper surface of the rotary table;
a polishing pad disposed on an upper surface of the polishing platen;
a polishing head opposed to the polishing pad; and
a device for measuring a thickness of a slurry, the device comprising:
a distance sensor disposed in the polishing platen for measuring a distance between the distance sensor and a wafer in the polishing head;
a distance converter disposed in the rotary table and coupled to the distance sensor for converting a measuring signal from the distance sensor into a standard electrical signal; and
a processing unit coupled to the distance converter for acquiring the standard electrical signal to obtain a thickness of the slurry between the polishing head and the polishing pad.

13. The chemical mechanical polishing apparatus according to claim 12, wherein a first groove is formed in the upper surface of the rotary table and covered by the polishing platen to define a first chamber, in which the distance converter is disposed in the first chamber.

14. The chemical mechanical polishing apparatus according to claim 12, wherein a second groove is formed in the upper surface of the polishing platen has and covered by the polishing pad to define a second chamber, in which the distance sensor is disposed in the second chamber.

15. A method for measuring a thickness of a slurry, comprising:
A) a static loading measurement, comprising: statically loading a wafer using the polishing head, sector scanning a whole surface of the wafer using the distance sensor of a device for measuring the thickness of the slurry, the device comprising: a distance sensor disposed in the polishing platen for measuring a distance between the distance sensor and a wafer in the polishing head; a distance converter disposed in the rotary table and coupled to the distance sensor for converting a measuring signal from the distance sensor into a standard electrical signal; and a processing unit coupled to the distance converter for acquiring the standard electrical signal to obtain a thickness of the slurry between the polishing head and the polishing pad, and measuring a distance between the distance sensor and a metal layer on the surface of the wafer using the distance sensor, thus obtaining a first distance; and
B) a dynamic rotating measurement, comprising: chemical mechanical polishing the wafer and measuring the distance between the distance sensor and the metal layer on the surface of the wafer using the distance sensor in a same way as that in Step A) to obtain a second distance, and calculating a difference between the second distance and the first distance as the thickness of the slurry.
